(19) United States
(12) Patent Application Publication
(10) Pub. No.: US 2026/0196612 A1
(43) Pub. Date: Jul. 9, 2026

(54) MANUFACTURING METHOD OF BATTERY CELL

(71) Applicant: TOYOTA JIDOSHA KABUSHIKI KAISHA, Toyota-Shi (JP)

(72) Inventor: Tsuyoshi EHARA, Toyota-Shi (JP)

(73) Assignee: TOYOTA JIDOSHA KABUSHIKI KAISHA, Toyota-Shi (JP)

(21) Appl. No.: 19/421,538

(22) Filed: Dec. 16, 2025

(30) Foreign Application Priority Data
Jan. 6, 2025 (JP) 2025-000766

(51) Int. Cl. H01M 50/121; H01M 10/0585; H01M 50/103; H01M 50/124

(52) U.S. Cl. CPC H01M 50/121; H01M 10/0585; H01M 50/103; H01M 50/1243

(57) ABSTRACT

A manufacturing method of a battery cell includes molding a resin sheet into a resin layer. The resin sheet includes an end face, a first side face, and a second side face. The end face faces in a first direction that follows a planar direction of an inner face in a disposed state. The first side face faces in a second direction that is perpendicular to the first direction and that also follows the planar direction. The first side face extends from the end face in a third direction that is a direction opposite to the first direction. The second side face faces in a fourth direction that is a direction opposite to the second direction. The second side face extends from the end face in the third direction. A dimension between the first side face and the second side face decreases farther away from the end face.

### CROSS-REFERENCE TO RELATED APPLICATION

This application claims priority to Japanese Patent Application No. 2025-000766 filed on January 6, 2025. The disclosure of the above-identified application, including the specification, drawings, and claims, is incorporated by reference herein in its entirety.

### BACKGROUND

### 1. Technical Field

The present disclosure relates to a manufacturing method of a battery cell.

### 2. Description of Related Art

Japanese Unexamined Patent Application Publication No. 2020-113496 (JP 2020-113496 A) discloses an all-solid-state battery cell in which an electrode laminate is encapsulated in an outer encasement material. A first thermal transfer material is disposed inside the outer encasement material so as to be in contact with the electrode laminate and the outer encasement.

### SUMMARY

When a member is disposed on an inner face of an outer encasement as in the related art, it is preferable that the adhesive strength between this member and the outer encasement is high. When this member is a resin layer, it is difficult to improve adhesion between the outer encasement and the resin layer while disposing the resin layer inside the outer encasement.

The present disclosure has been made in consideration of the above-mentioned problem, and an object thereof is to provide a manufacturing method of a battery cell that can improve adhesive strength between the outer encasement and the resin layer.

A manufacturing method of a battery cell according to an aspect of the present disclosure is a manufacturing method of a battery cell that includes an outer encasement including a first wall portion, a resin layer, and an electrode assembly, the manufacturing method including disposing a resin sheet on an inner face of the first wall portion, molding the resin sheet into the resin layer by compressing the resin sheet disposed on the inner face toward the inner face, and disposing the electrode assembly on a side of the resin layer that is opposite to the first wall portion. The resin sheet includes an end face, a first side face, and a second side face. The end face faces in a first direction that follows a planar direction of the inner face in a disposed state in which the resin sheet is disposed on the inner face. In the disposed state, the first side face faces in a second direction that is perpendicular to the first direction and that also follows the planar direction. In the disposed state, the first side face extends from the end face in a third direction that is a direction opposite to the first direction. In the disposed state, the second side face faces in a fourth direction that is a direction opposite to the second direction. In the disposed state, the second side face extends from the end face in the third direction. A dimension between the first side face and the second side face decreases farther away from the end face.

According to the present disclosure, the adhesion strength between the outer encasement and the resin layer can be improved.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1A is a diagram illustrating a battery cell that is manufactured using a method according to an embodiment of the present disclosure;

FIG. 1B is a diagram illustrating the battery cell that is manufactured using the method according to the embodiment of the present disclosure;

FIG. 1C is a diagram illustrating the battery cell that is manufactured using the method according to the embodiment of the present disclosure;

FIG. 2 is a flowchart showing a manufacturing method of the battery cell according to the embodiment of the present disclosure;

FIG. 3A is a diagram illustrating a state immediately after a resin sheet is disposed on an inner face of a first wall portion;

FIG. 3B is a diagram illustrating the state immediately after the resin sheet is disposed on the inner face of the first wall portion;

FIG. 4A is a diagram illustrating a state immediately after compressing the resin sheet to mold a resin layer;

FIG. 4B is a diagram illustrating the state immediately after compressing the resin sheet to mold the resin layer;

FIG. 5A is a diagram illustrating a state immediately after a resin member is disposed on an inner face of a first wall portion in a comparative example;

FIG. 5B is a diagram illustrating the state immediately after the resin member is disposed on the inner face of the first wall portion in the comparative example;

FIG. 6A is a diagram illustrating a state immediately after compressing the resin member in the comparative example; and

FIG. 6B is a diagram illustrating the state immediately after compressing the resin member in the comparative example.

### DETAILED DESCRIPTION OF EMBODIMENTS

A manufacturing method of a battery cell according to an embodiment of the present disclosure will be described below with reference to the drawings. The same reference signs denote the same or equivalent portions in the drawings, and the description of such portions will not be repeated.

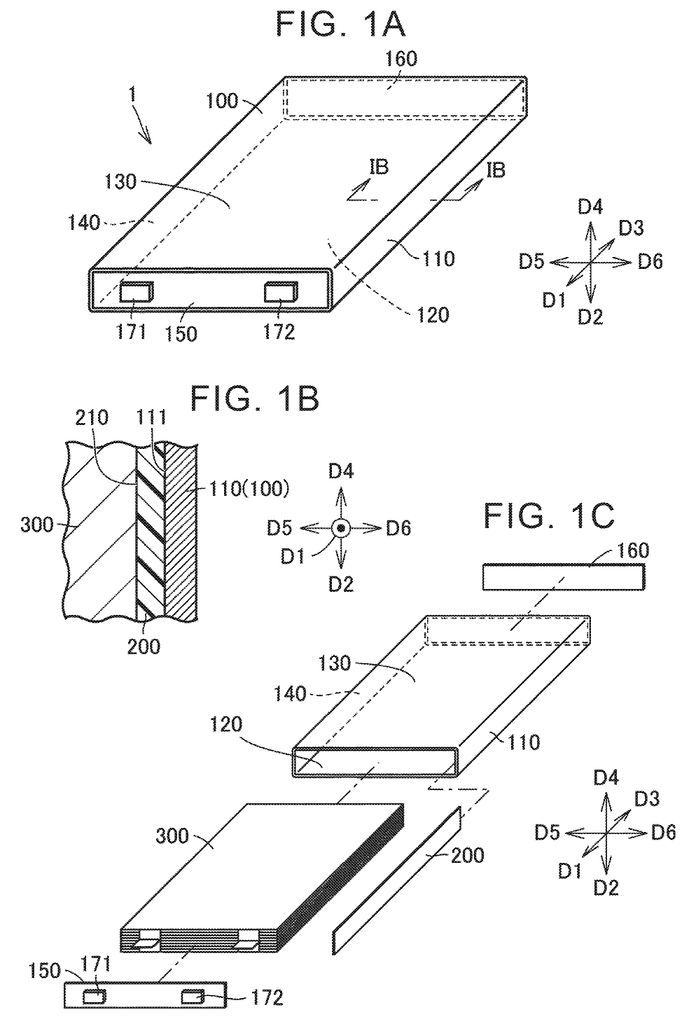

First, a battery cell manufactured using a method according to the embodiment of the present disclosure will be described. FIGS. 1A,1B and 1C are diagrams illustrating the battery cell manufactured using the method according to the embodiment of the present disclosure. FIG. 1A is a perspective view of the battery cell. FIG. 1B is a partial cross-sectional view of the battery cell as viewed from a direction of arrows along line IB-IB in FIG. 1A. FIG. 1C is an exploded perspective view of the battery cell.

As illustrated in FIGS. 1A,1B and 1C, a battery cell 1 manufactured using the method according to the embodiment of the present disclosure includes an outer encasement 100, a resin layer 200, and an electrode assembly 300. The battery cell 1 may be a secondary battery such as a lithium-ion secondary battery, a nickel metal hydride battery, or the like. The battery cell 1 may be a solid-state battery.

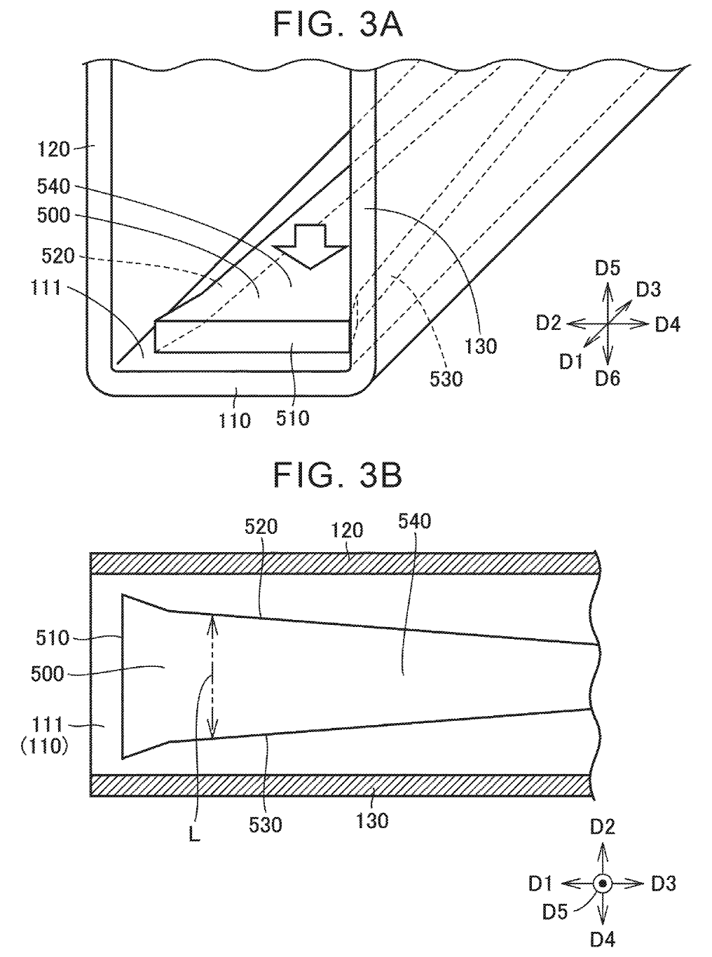

The outer encasement 100 includes a first wall portion 110, a second wall portion 120, a third wall portion 130, a fourth wall portion 140, a first lid portion 150, and a second lid portion 160. FIGS. 1A,1B and 1C, and FIGS. 3A,3B,4A and 4B described below, indicate directions "D1" to "D6", with the first wall portion 110 as the reference. "D1" indicates a first direction, "D2" indicates a second direction, "D3" indicates a third direction, "D4" indicates a fourth direction, "D5" indicates a fifth direction, and "D6" indicates a sixth direction. The second direction is orthogonal to the first direction. The third direction is an opposite direction to the first direction. The fourth direction is an opposite direction to the second direction. The fifth direction is a direction orthogonal to both the first direction and the second direction. The sixth direction is an opposite direction to the fifth direction.

The first wall portion 110 has a plate-like outer shape. The first wall portion 110 includes an inner face 111. A planar direction of the inner face 111 is along both the first direction and the second direction. The inner face 111 faces in the fifth direction. The inner face 111 has a rectangular outer shape as viewed from the fifth direction. The inner face 111 has a long side that is parallel to the first direction, and a short side that is parallel to the second direction.

The second wall portion 120 has a plate-like outer shape. The second wall portion 120 extends from the first wall portion 110 in the fifth direction. The second wall portion 120 extends in parallel to the first direction. The second wall portion 120 has a rectangular outer shape as viewed from the second direction.

The third wall portion 130 has a plate-like outer shape. The third wall portion 130 extends from the first wall portion 110 in the fifth direction. The third wall portion 130 extends parallel to the first direction. The third wall portion 130 has a rectangular outer shape as viewed from the fourth direction. The inner face 111 of the first wall portion 110 is situated between the second wall portion 120 and the third wall portion 130 as viewed from the fifth direction.

The fourth wall portion 140 has a plate-like outer shape. The fourth wall portion 140 connects an end portion of the second wall portion 120 on the fifth direction side and an end portion of the third wall portion 130 on the fifth direction side. The fourth wall portion 140 extends parallel to the first wall portion 110.

The first wall portion 110, the second wall portion 120, the third wall portion 130, and the fourth wall portion 140 are made of a single material, and specifically are made of a metal such as aluminum.

The first lid portion 150 is fixed to one open end of a substantially rectangular tubular body made up of the first wall portion 110, the second wall portion 120, the third wall portion 130, and the fourth wall portion 140. The first lid portion 150 may be fixed to the open end by welding. The first lid portion 150 is provided with a first external terminal 171 and a second external terminal 172.

The second lid portion 160 is fixed to another open end of the substantially rectangular tubular body made up of the first wall portion 110, the second wall portion 120, the third wall portion 130, and the fourth wall portion 140. The second lid portion 160 may be fixed to the open end by welding. The first external terminal 171 and the second external terminal 172 may be provided on the second lid portion 160.

The resin layer 200 is disposed on the inner face 111 of the first wall portion 110. The resin layer 200 is disposed so as to be in contact with both the second wall portion 120 and the third wall portion 130. The resin layer 200 includes a layer surface 210. The layer surface 210 faces in the fifth direction. The layer surface 210 extends parallel to the planar direction of the inner face 111.

The resin layer 200 has electrical insulation properties. The resin layer 200 may be a member for performing thermal transfer of heat from the electrode assembly 300 toward the first wall portion 110.

The electrode assembly 300 is also referred to as a battery element. In the electrode assembly 300, a cathode and an anode are stacked together with a separator interposed therebetween (all omitted from illustration). These layers are stacked in the second direction, but may be stacked in the fifth direction instead. The electrode assembly 300 may include a solid electrolyte instead of the separator. One of the first external terminal 171 and the second external terminal 172 is electrically connected to the cathode, and the other is electrically connected to the anode. The electrode assembly 300 is housed in the outer encasement 100. The electrode assembly 300 may be in contact with the resin layer 200.

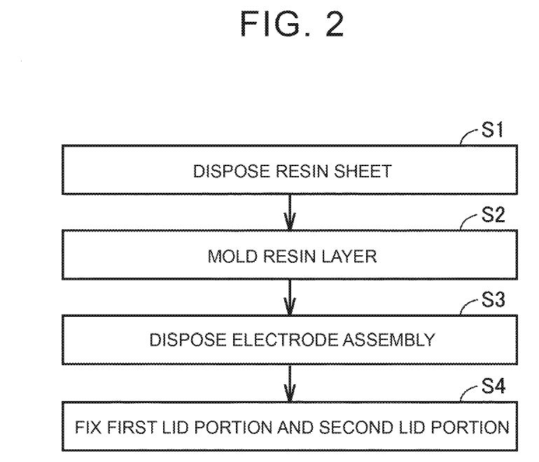

Next, the manufacturing method of the battery cell 1 according to the embodiment of the present disclosure will be described. FIG. 2 is a flowchart showing the manufacturing method of the battery cell according to the embodiment of the present disclosure. As shown in FIG. 2, the manufacturing method a battery cell according to one embodiment of the present disclosure includes step S1 of disposing a resin sheet, step S2 of molding of a resin layer, step S3 of disposing an electrode assembly, and step S4 of fixing the first lid portion and the second lid portion.

FIGS. 3A and 3B are diagrams illustrating a state immediately after the resin sheet is disposed on the inner face of the first wall portion. FIG. 3A is a perspective view as viewed from the first direction side, and FIG. 3B is a plan view of the first wall portion 110 as viewed from the inner face 111 side.

As illustrated in FIGS. 3A and 3B, in step S1, a resin sheet 500 is disposed on the inner face 111 of the first wall portion 110. Note that in step S1, the first wall portion 110, the second wall portion 120, the third wall portion 130, and the fourth wall portion 140 are in a state before the first lid portion 150 and the second lid portion 160 are fixed thereto.

The resin sheet 500 has electrical insulation properties. The resin sheet 500 includes an end face 510, a first side face 520, a second side face 530, and a pressure-receiving face 540.

The end face 510 faces in the first direction in a disposed state in which the resin sheet 500 is disposed on the inner face 111. The end face 510 extends substantially parallel to the second direction. The end face 510 also extends substantially parallel to the fifth direction.

In the disposed state, the first side face 520 faces in the second direction. In the disposed state, the first side face 520 extends in the third direction from an edge of the end face 510 on the second direction side. In the disposed state, the first side face 520 extends so as to be farther away from the second wall portion 120 the farther in the third direction.

In the disposed state, the second side face 530 faces in the fourth direction. In the disposed state, the second side face 530 extends in the third direction from an edge of the end face 510 on the fourth direction side. In the disposed state, the second side face 530 extends so as to be farther away from the third wall portion 130 the farther in the third direction. A dimension L between the first side face 520 and the second side face 530 decreases the farther away from the end face 510.

In the disposed state, the pressure-receiving face 540 faces in the fifth direction. In the disposed state, the pressure-receiving face 540 extends parallel to the planar direction.

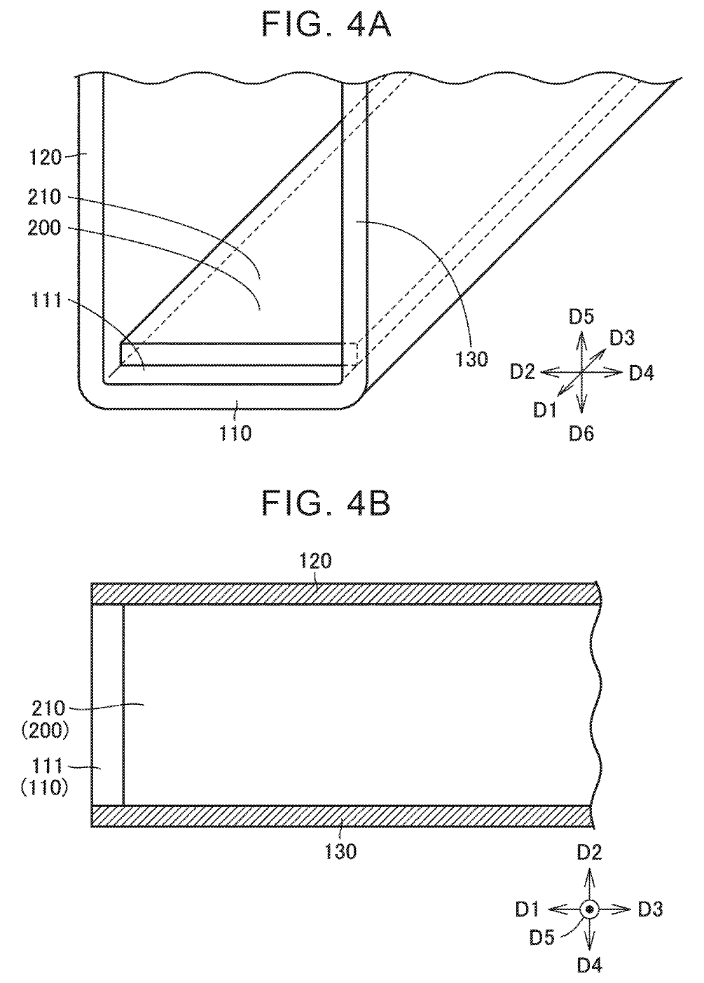

In step S2, the resin sheet 500 disposed on the inner face 111 is compressed toward the inner face 111, thereby molding the resin sheet 500 into the resin layer 200. FIGS. 4A and 4B are diagrams illustrating a state immediately after compressing the resin sheet to mold the resin layer. FIG. 4A is a perspective view as viewed from the first direction side, and FIG. 4B is a plan view of the first wall portion 110 as viewed from the inner face 111 side.

As illustrated in FIGS. 3A and 3B, the resin sheet 500 is disposed so as to be spaced away from both the second wall portion 120 and the third wall portion 130. However, as illustrated in FIGS. 4A and 4B, the resin layer 200 is molded so as to be in contact with both the second wall portion 120 and the third wall portion 130. The resin sheet 500 is compressed to be molded into the resin layer 200 such that the thickness of the resin layer 200 in the fifth direction is 0.6 times or more the thickness of the resin sheet 500, to 0.8 times or less the thickness thereof, in the fifth direction in the disposed state thereof.

In step S3, the electrode assembly 300 is disposed on the opposite side of the resin layer 200 from the first wall portion 110 (see FIGS. 1A,1B and 1C). More specifically, the electrode assembly 300 is disposed so as to be surrounded by the resin layer 200, the second wall portion 120, the third wall portion 130, and the fourth wall portion 140.

In step S4, the first lid portion 150 and the second lid portion 160 are fixed to the first wall portion 110, the second wall portion 120, the third wall portion 130, and the fourth wall portion 140. Thus, the electrode assembly 300 is housed in the outer encasement 100, and the outer encasement 100 is sealed off.

Here, a manufacturing method of a battery cell according to a comparative example will be described. The manufacturing method of the battery cell according to the comparative example differs from the present embodiment only in that a resin member is disposed instead of the resin sheet.

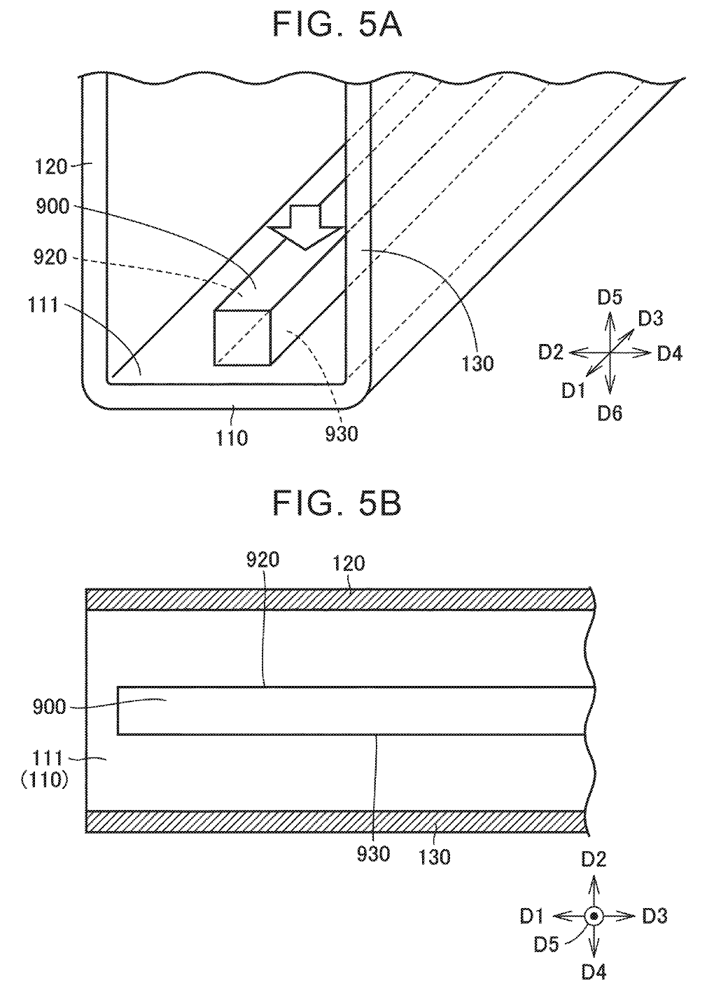

FIGS. 5A and 5B are diagrams illustrating a state immediately after the resin member is disposed on the inner face of the first wall portion in the comparative example. FIG. 5A is a perspective view as viewed from the first direction side, and FIG. 5B is a plan view of the first wall portion 110 as viewed from the inner face.

As illustrated in FIGS. 5A and 5B, a dimension between a first side face 920 and a second side face 930 of the resin member 900 does not change along the third direction. Also, the first side face 920 extends parallel to the second wall portion 120, and the second side face 930 extends parallel to the third wall portion 130.

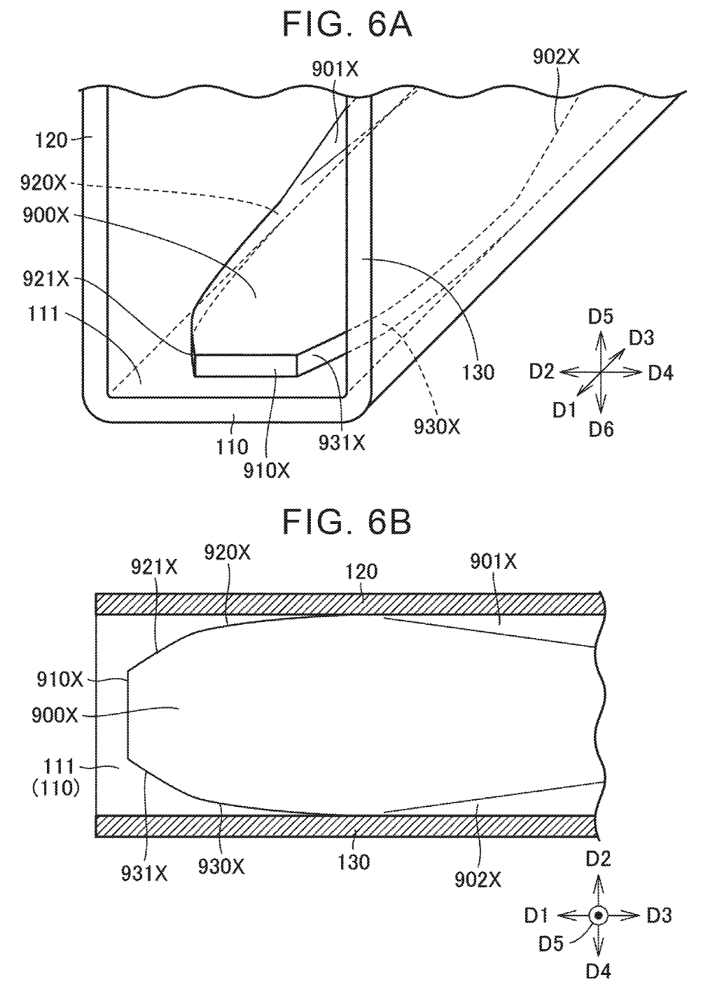

FIGS. 6A and 6B are diagrams illustrating a state immediately after compressing the resin member in the comparative example. FIG. 6A is a perspective view as viewed from the first direction side, and FIG. 6B is a plan view of the first wall portion 110 as viewed from the inner face 111 side.

As illustrated in FIGS. 6A and 6B, the farther away from an end face 910X, the greater the expansion of a first side face 920X in the second direction is, and the greater the expansion of a second side face 930X in the fourth direction is. Accordingly, in a post-compression resin member 900X, portions 901X and 902X that are away from the end face 910X and that are in contact with the second wall portion 120 and the third wall portion 130 respectively, each bulge upward in the fifth direction. A gap is also formed between the second wall portion 120 and a nearby region 921X of the first side face 920X in the vicinity of the end face 910X. Also, a gap is formed between the third wall portion 130 and a nearby region 931X of the second side face 930X in the vicinity of the end face 910X.

On the other hand, the manufacturing method of the battery cell 1 according to the embodiment of the present disclosure is the manufacturing method of the battery cell 1 that includes the outer encasement 100 including the first wall portion 110, the resin layer 200, and the electrode assembly 300, the method including disposing the resin sheet 500 on the inner face 111 of the first wall portion 110, compressing the resin sheet 500 disposed on the inner face 111 toward the inner face 111 to mold the resin sheet 500 into the resin layer 200, and disposing the electrode assembly 300 on the opposite side of the resin layer 200 from the first wall portion 110. The resin sheet 500 includes the end face 510, the first side face 520, and the second side face 530. The end face 510 faces in the first direction that follows the planar direction of the inner face 111 in the disposed state in which the resin sheet 500 is disposed on the inner face 111. In the disposed state, the first side face 520 faces in the second direction that is perpendicular to the first direction and also follows the planar direction. In the disposed state, the first side face 520 extends from the end face 510 in the third direction that is the opposite direction to the first direction. In the disposed state, the second side face 530 faces in the fourth direction that is the opposite direction to the second direction. In the disposed state, the second side face 530 extends from the end face 510 in the third direction. A dimension L between the first side face 520 and the second side face 530 decreases the farther away from the end face 510.

When the resin sheet 500 is compressed toward the inner face 111, the farther away from the end face 510, the greater the expansion of the first side face 520 in the second direction is, and the greater the expansion of the second side face 530 in the fourth direction is (see comparative example). Now, the dimension L between the first side face 520 and the second side face 530 has been made to decrease the farther away from the end face 510 in advance, as in the above-described configuration, and accordingly a widthwise dimension of the resin layer 200 that is molded, in the second direction (fourth direction), becomes relatively uniform. As a result, pressure can be applied relatively uniformly to the resin layer 200 (resin sheet 500), and the resin layer 200 and the first wall portion 110 can be brought into close contact with each other. Accordingly, adhesive strength between the outer encasement 100 and the resin layer 200 can be improved.

Also, in the present embodiment, the outer encasement 100 further includes the second wall portion 120 and the third wall portion 130. The second wall portion 120 extends from the first wall portion 110 in the fifth direction, which is the direction in which the inner face 111 faces. The second wall portion 120 extends in parallel to the first direction. The third wall portion 130 extends from the first wall portion 110 in the fifth direction. The third wall portion 130 extends parallel to the first direction. The inner face 111 is situated between the second wall portion 120 and the third wall portion 130 as viewed from the fifth direction. The resin layer 200 is molded so as to be in contact with both the second wall portion 120 and the third wall portion 130.

Even when the resin layer 200 is molded so as to come into contact with both the second wall portion 120 and the third wall portion 130 as in the above-described configuration, in the present embodiment, the dimension L between the first side face 520 and the second side face 530 decreases the farther away from the end face 510. This enables the resin layer 200 that is molded to be suppressed from bulging up near the second wall portion 120 and the third wall portion 130 the farther away from the end face 510 (see comparative example). Furthermore, damage to the resin layer 200 or to the outer encasement 100, caused by localized pressure being applied to bulging portions of the resin layer 200, can be suppressed. Also, even with the second wall portion 120 and the third wall portion 130 being present, pressure can be applied relatively uniformly to the resin layer 200 (resin sheet 500), and the resin layer 200 and the first wall portion 110 can be brought into close contact with each other.

Also, in the present embodiment, in the disposed state, the first side face 520 extends so as to be farther away from the second wall portion 120 the farther in the third direction. In the disposed state, the second side face 530 extends so as to be farther away from the third wall portion 130 the farther in the third direction.

According to the above-described configuration, when the resin sheet 500 is compressed, the first side face 520 expands more in the second direction and the second side face 530 expands more in the fourth direction the farther away from the end face 510, which is utilized such that the resin sheet 500 can be molded into a shape that conforms to the second wall portion 120 and the third wall portion 130. Furthermore, pressure can be applied relatively uniformly to the resin layer 200 (resin sheet 500), and the resin sheet 500, and the second wall portion 120 and the third wall portion 130, can be brought into close contact with each other.

In the present embodiment, the resin sheet 500 further includes the pressure-receiving face 540. In the disposed state, the pressure-receiving face 540 faces in the fifth direction. In the disposed state, the pressure-receiving face 540 extends parallel to the planar direction. The resin layer 200 includes the layer surface 210 facing in the fifth direction. The layer surface 210 extends parallel to the planar direction.

According to the above-described configuration, the first side face 520 and the second side face 530 have the configuration described above, and accordingly even when the resin sheet 500 has a relatively simple shape in which the pressure-receiving face 540 extends in parallel to the aforementioned planar direction, the resin layer 200 can be readily molded such that the layer surface 210 extends parallel to the aforementioned planar direction.

Also, in the present embodiment, the thickness of the resin layer 200 in the fifth direction is 0.6 times or more the thickness of the resin sheet 500 to 0.8 times or less the thickness thereof, in the fifth direction in the disposed state thereof.

According to the above configuration, the resin layer 200 can be molded with a relatively small pressure without compressing the resin sheet 500 to half or less.

In the above description of the embodiment, configurations that can be combined may be combined with each other.

The embodiment disclosed herein should be considered to be exemplary in all respects and not restrictive. The scope of the present disclosure is defined by the claims rather than by the above description, and is intended to include all modifications that fall within the meaning and scope equivalent to those of the claims.

What is claimed is:

1. A manufacturing method of a battery cell that includes an outer encasement including a first wall portion, a resin layer, and an electrode assembly, the manufacturing method comprising:
disposing a resin sheet on an inner face of the first wall portion;
molding the resin sheet into the resin layer by compressing the resin sheet disposed on the inner face toward the inner face; and
disposing the electrode assembly on a side of the resin layer that is opposite to the first wall portion, wherein
the resin sheet includes an end face, a first side face, and a second side face,
the end face faces in a first direction that follows a planar direction of the inner face in a disposed state in which the resin sheet is disposed on the inner face,
in the disposed state, the first side face faces in a second direction that is perpendicular to the first direction and that also follows the planar direction,
in the disposed state, the first side face extends from the end face in a third direction that is a direction opposite to the first direction,
in the disposed state, the second side face faces in a fourth direction that is a direction opposite to the second direction,
in the disposed state, the second side face extends from the end face in the third direction, and
a dimension between the first side face and the second side face decreases farther away from the end face.

2. The manufacturing method according to claim 1, wherein
the outer encasement further includes a second wall portion and a third wall portion,
the second wall portion extends from the first wall portion in a fifth direction that is a direction in which the inner face faces,
the second wall portion extends parallel to the first direction,
the third wall portion extends from the first wall portion in the fifth direction,
the third wall portion extends parallel to the first direction,
the inner face is situated between the second wall portion and the third wall portion as viewed from the fifth direction, and
the resin layer is molded so as to be in contact with both the second wall portion and the third wall portion.

3. The manufacturing method according to claim 2, wherein
in the disposed state, the first side face extends so as to be farther away from the second wall portion farther in the third direction, and
in the disposed state, the second side face extends so as to be farther away from the third wall portion farther in the third direction.

4. The manufacturing method according to claim 2, wherein
the resin sheet further includes a pressure-receiving face,
in the disposed state, the pressure-receiving face faces in the fifth direction,
in the disposed state, the pressure-receiving face extends parallel to the planar direction,
the resin layer includes a layer surface facing in the fifth direction, and
the layer surface extends parallel to the planar direction.

5. The manufacturing method according to claim 4, wherein, in the disposed state, a thickness of the resin layer in the fifth direction is 0.6 times or more a thickness of the resin sheet to 0.8 times or less the thickness of the resin sheet, in the fifth direction.
